(19) United States
(12) Patent Application Publication
(10) Pub. No.: US 2006/0165141 A1
(43) Pub. Date: Jul. 27, 2006

(54) Method and device for pumping a laser

(75) Inventors: Daniel Kopf, Altach (AT); Maximillian Josef Lederer, Alberschwende (AT); Ingo Johannsen, Lauterach (AT)

Correspondence Address: OLIFF & BERRIDGE, PLC, P.O. BOX 19928, ALEXANDRIA, VA, 22320, US

(73) Assignee: HIGH Q LASER PRODUCTION GMBH, Hohenems (AU)

(21) Appl. No.: 10/558,559

(22) PCT Filed: May 28, 2004
(86) PCT No.: PCT/EP04/05813

§ 371 Date: Nov. 29, 2005

Related U.S. Application Data
(60) Provisional application No. 60/474,227, filed on May 30, 2003.

(30) Foreign Application Priority Data
Oct. 23, 2003 (CH) 01816/03

(51) Int. Cl. H01S 3/04; H01S 3/091

(52) U.S. Cl. 372/36; 372/70

(57) ABSTRACT

The invention relates to a method and devices for pumping a laser, and to a laser element, which is specially designed therefor and which contains laser-active material. In order to prevent the laser-active material from being subjected to excessive thermal stress, particularly during a thin disk setup, an, in essence, elongated pumped light spot is irradiated onto a laser medium placed on a temperature sink whereby producing a two-dimensional heat flow. This achieves an improved cooling and a reduction of the maximum temperature.

The invention relates to a method for pumping a laser according to the preamble of claim 1, a laser element according to the preamble of claim 9, and a laser arrangement according to the preamble of claim 16.

A fundamental requirement of laser setups for industrial as well as scientific applications is as high an input as possible of power into a laser-active medium. In a widely used type of solid-state laser, this is effected by pumping by means of light which is emitted by one or more semiconductor lasers and is guided onto the solid containing or consisting of is laser-active material. During the pumping, the solid heats up so that there is an increased power input associated with a basically undesired temperature increase.

The problems due to thermal stress arise in these systems firstly because of damage to the solid itself or due to undesired influences on the radiation field in the solid. Thermal lenses constitute one example of such an effect.

A critical parameter influencing these effects is the heat conduction within the solid as well as the heat transport through the interfaces or boundary layers of the laser-active solid. A standard solution for reducing the thermal effects is the thin-disk laser, as disclosed, for example, in EP 0 632 551 B1, this document being hereby incorporated by reference.

In such lasers, the laser medium is in the form of a flat disk and is applied with one of its flat sides to a temperature sink which is generally in the form of a solid cooling element. Owing to the advantageous ratio of surface area to volume, heat transport which provides sufficient cooling of the laser medium and hence prevents adverse effects on the material and radiation fields can be achieved even at high transport volumes. The extensive design of the material results in formation of a temperature gradient which, in the core region of the radiation field, is parallel to its direction of propagation. Comparative homogeneity of the temperature over a large region of the beam cross-section can be achieved thereby, so that the heat flow is substantially one-dimensional and thermal lenses are avoided. The beam cross-sections used for pumping such lasers are designed to be round in order to achieve this one-dimensional heat flow and are adapted to the geometry of the laser material.

Solutions of the prior art as are also known, for example, from “Widely tunable pulse durations from a passively mode-locked thin-disk Yb:YAG laser”, F. Brunner et al. (Optics Letters 26, No. 2, pages 379-381) or “60-W average power in 810-fs pulses from a thin-disk Yb:YAG laser”, E. Innerhofer et al. (Optics Letters 28, No. 5, pages 367-369), emphasize the one-dimensionality of the heat flow and attempt to optimize the ratio of surface area to volume by keeping one dimension of the laser medium as small as possible and the other two dimensions on the other hand as large as possible, but at least substantially larger than the thickness of the laser medium. The two documents are hereby incorporated in their entirety by reference.

Thus, according to the prior art, the laser is designed for achieving low temperatures or an advantageous heat flow, especially by reducing the layer thickness of the laser medium with a geometrically adapted pumped light spot.

A further problem is the focusing of the pumped light sources into a round spot. The focusing of many pumped lasers into a spot requires comparatively complicated apparatus, which is also associated with difficulties of adjustment.

A further problem is the handling of the thin, lamellar laser media in the application process, particularly since an increasing reduction of the thickness also entails reduced resistance to mechanical stress.

It is therefore an object to achieve a temperature of the laser medium which is lower compared with the prior art in combination with the same incident power and power density—and hence the same theoretical amplification factor—or a higher inputtable power at the same temperature, without the occurrence of thermal effects which cannot be tolerated or cannot be taken into account.

A further object is to simplify the beam guidance for focusing the pumped light sources in a pumped light spot.

A further object is to simplify the setup of the laser, in particular to reduce the necessary components and to simplify the orientation of the components.

It is a further object to increase the stability of the laser medium, in particular with regard to the handling of the components during production.

These objects are achieved, according to the invention by features of claims 1, 9 and 16, respectively or by features of the subclaims, or the solutions are further developed.

According to the invention, the laser medium in a thin-disk laser is illuminated by an elongated or elliptical pumped light spot. This pumped light spot has a basic elongated shape, it being possible for the ratio of length to width to be 2:1, 3:1, 5:1, 10:1 or even higher. In particular, a high-aspect-ratio laser spot can also be used according to the invention. The elongated pumped light spot results in a two-dimensional heat flow which, compared with solutions of the prior art, leads to a reduction in the maximum temperature.

With adaptation to the geometry of the pumped light spot, the solid too may be in the form of an elongated, extensive or ingot-like solid, but in principle differences between the geometries of pumped light spot and laser medium also permit the effect according to the invention. For an adaptation, according to the invention, to elongated pumped light geometry, at least one first dimension of the solid is chosen to be substantially greater than the thickness of the solid.

The other dimension is substantially smaller than the first dimension in order to achieve two-dimensional cooling. Based on the thickness of the solid, this dimension can be chosen to be less than, equal to or greater than the thickness of the solid. An improvement in the cooling is thus achieved according to the invention by greatly increasing one of the two extensive dimensions of the cooling surface relative to the other. By choosing the dimensions of the laser medium in a manner suitable according to the invention, the maximum temperature can thus be greatly reduced compared with, for example, the disk-like form of the laser medium, with identical power. This laser medium is applied in a manner known per se to a temperature sink. A reflective layer can be introduced between temperature sink and laser medium. The laser medium can also carry one or more layers, for example for reducing reflection, on the side facing away from the cooling.

Pumped light in the form of a pumped light spot is focused onto the laser medium, it being possible for the geometries of the area of the laser medium and of the pumped light spot advantageously to be tailored to one another. The pumped light spot may also be composed of the image of individual emitters or may be formed by multiple reflections. An example of a suitable superposition of the radiation of different emitters is disclosed in WO 00/77893 and U.S. patent application Ser. No. 10/006,396. A suitable solution for generating a multiple reflection is described in U.S. Provisional Patent Application No. 60/442,917. A folding element according to the invention which is described therein has at least two reflective planes tilted or running toward one another, between which the beam path is guided. These planes may be both outer surfaces of a plurality of reflective elements and insides of a single element. In other words, the reflection takes place at a transition of at least two media which have a different optical refractive index. All documents mentioned are hereby incorporated by reference in their entirety.

In addition, as a result of the elongated shape of the pumped light spot, there is a homogeneous temperature in the major part of the spot, which prevents heat transport in the longitudinal direction thereof. The heat flow is therefore substantially transverse to the longitudinal direction of the laser medium or to the temperature sink and hence two-dimensional. In comparison with a round geometry of the pumped light spot, the maximum temperature is greatly reduced so that, with the same power, a temperature difference per unit length which is of the order of magnitude of the round geometry also occurs transversely to the beam direction, so that effects occurring as a result of the thermal lens formation are negligible or at least remain compensatable. Thus, for example with an elongated, for example elliptical, pumped spot of 10 mm length and 0.1 mm width, the same area of a round pumped spot of 1 mm² can be used, but with improved cooling. Although the effect of purely extensive cooling is reduced with an elongated design, according to the invention, of laser medium and pumped or illuminated area, the effect of thermal lenses can be kept small by the greatly reduced maximum temperature, even in the case of multidimensional heat flow.

For further improvement of the cooling effect and for increasing the mechanical load capacity, a further layer of a material having the same refractive index as the laser medium can also be applied to that side of the laser medium which is opposite to the temperature sink. A layer of the same material as the laser-active medium is advantageous, but this is not doped. Joining of the two layers can be effected by diffusion bonding. Such a further layer also results in improved heat transport through the cooling surface in a direction opposite to the temperature sink, so that the cooling is further improved and a further reduction in the maximum temperature is achieved. In addition, the mechanical stability of the laser medium is increased and hence the production process is improved or can be made more advantageous.

The dimensioning, according to the invention, of the pumped light spot and the adaptation of the pumped light spot and laser medium and laser arrangements according to the invention which can be realized thereby are described in more detail purely by way of example below with reference to embodiments shown schematically in the drawing. Specifically,

FIG. 1 shows the schematic diagram of laser medium and pumped light beam of a laser arrangement according to the invention;

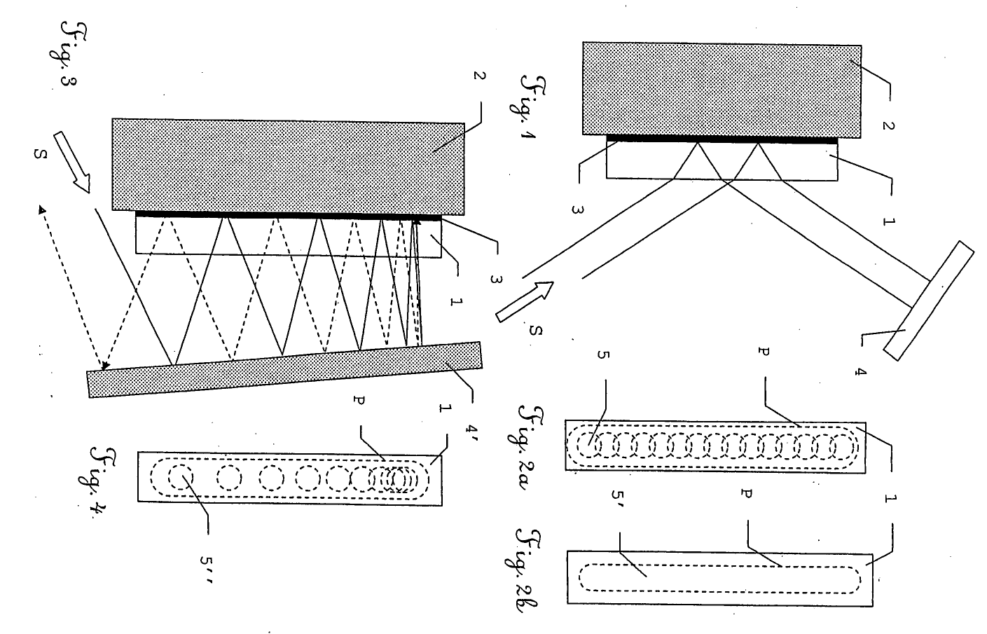

FIG. 2a-b shows the schematic diagram of the pumped light geometries for focusing onto the laser medium;

FIG. 3 shows the schematic diagram of a beam path with multiple reflections in a laser arrangement according to the invention;

FIG. 4 shows the schematic diagram of the focusing of pumped light onto the laser medium for an embodiment of the laser arrangement according to the invention which comprises multiple reflection;

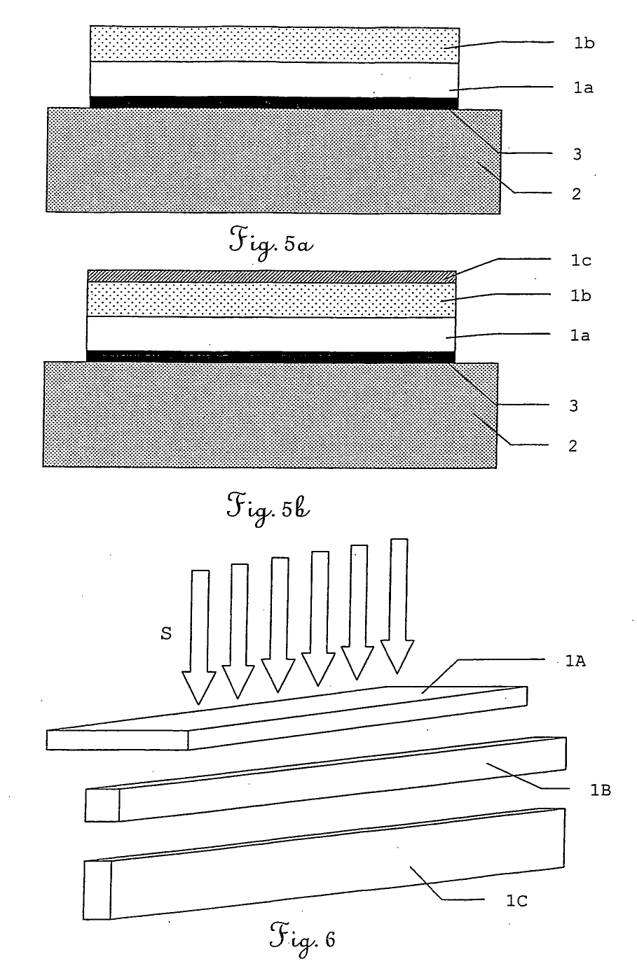

FIG. 5a-b shows the schematic diagram of layer superstructures according to the invention of the solid to be pumped;

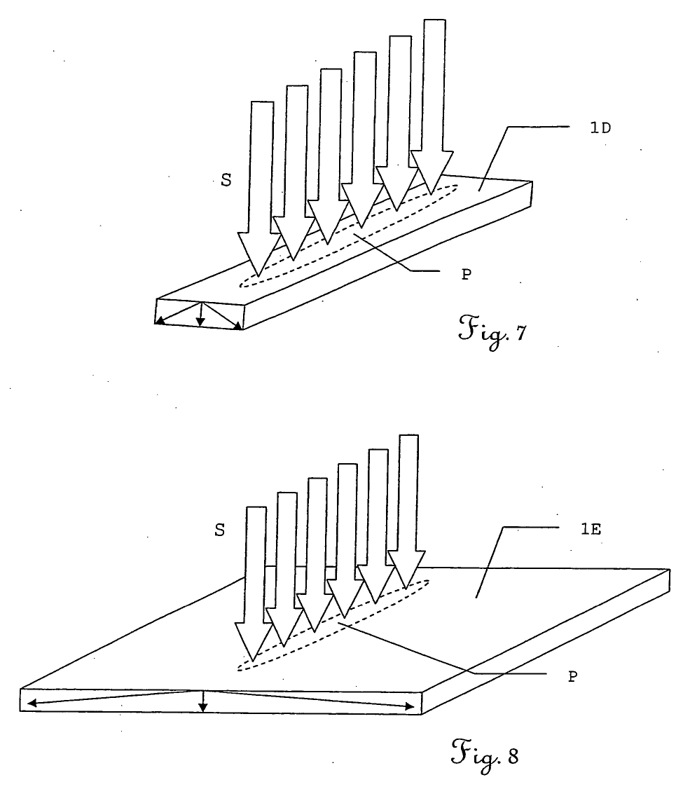

FIG. 6 shows the schematic diagram of advantageous forms of the solid to be pumped according to the invention;

FIG. 7 shows the schematic diagram of a first embodiment of the solid to be pumped according to the invention;

FIG. 8 shows the schematic diagram of a second embodiment of the solid to be pumped according to the invention;

FIG. 9 shows the modeling of a solid with pumped light spot according to the prior art by means of the method of finite elements;

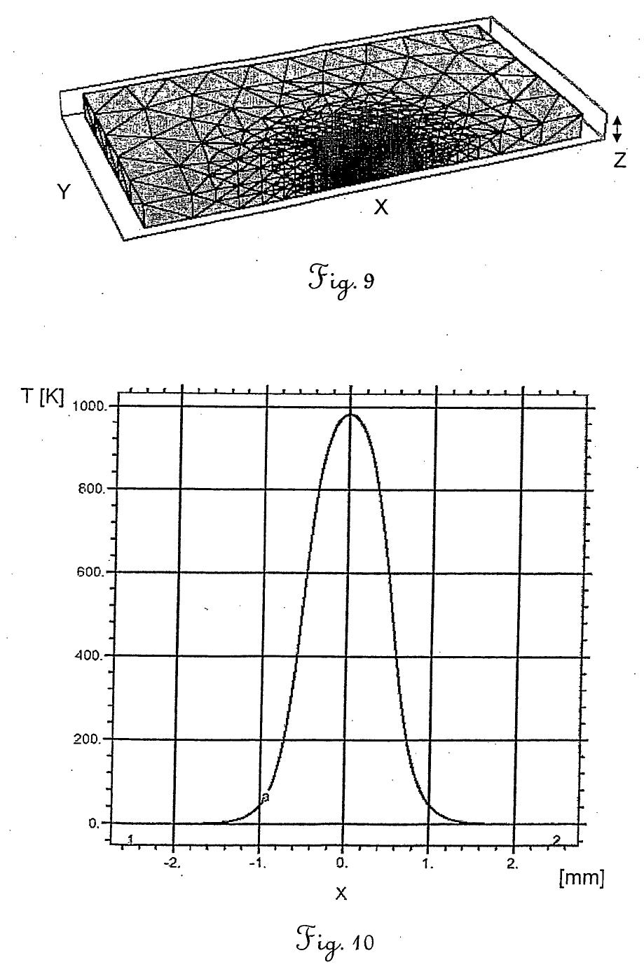

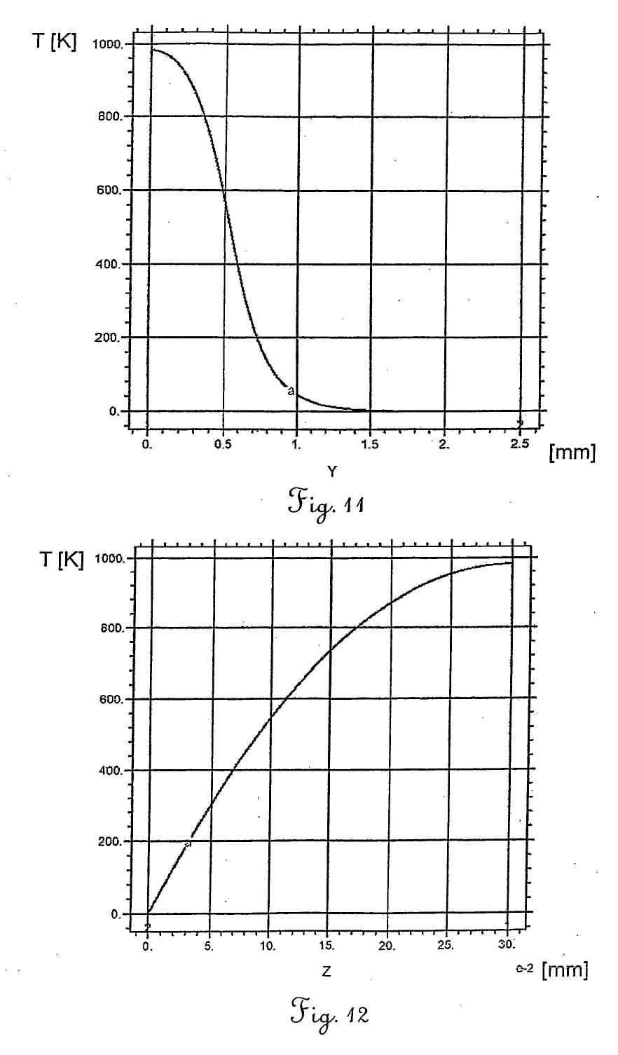

FIG. 10 shows the temperature curve in the X-direction through the solid according to FIG. 9;

FIG. 11 shows the temperature curve in the Y-direction through the solid according to FIG. 9;

FIG. 12 shows the temperature curve in the Z-direction through the solid according to FIG. 9;

FIG. 13 shows the modeling of a first solid with pumped light spot according to the invention by means of the method of finite elements;

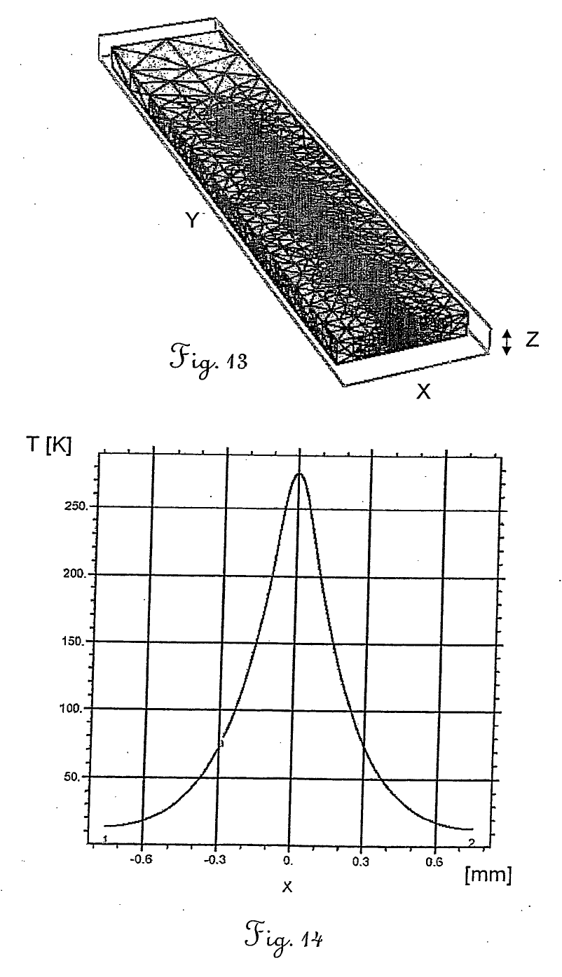

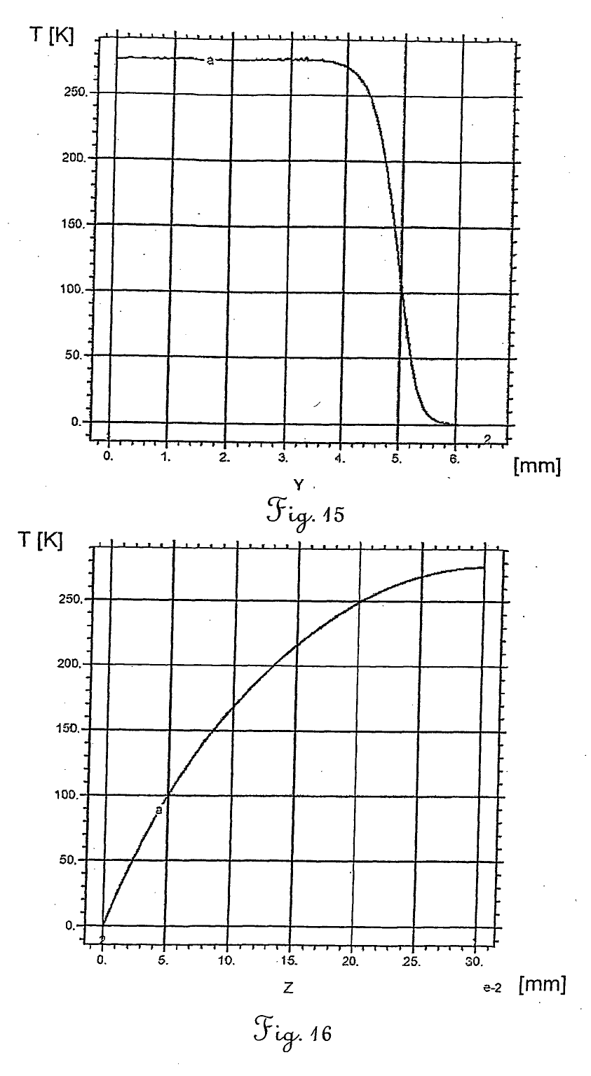

FIG. 14 shows the temperature curve in the X-direction through the solid according to FIG. 13;

FIG. 15 shows the temperature curve in the Y-direction through the solid according to FIG. 13;

FIG. 16 shows the temperature curve in the Z-direction through the solid according to FIG. 13;

FIG. 17 shows the modeling of a second solid according to the invention with pumped light spot according to the invention by means of the method of finite elements;

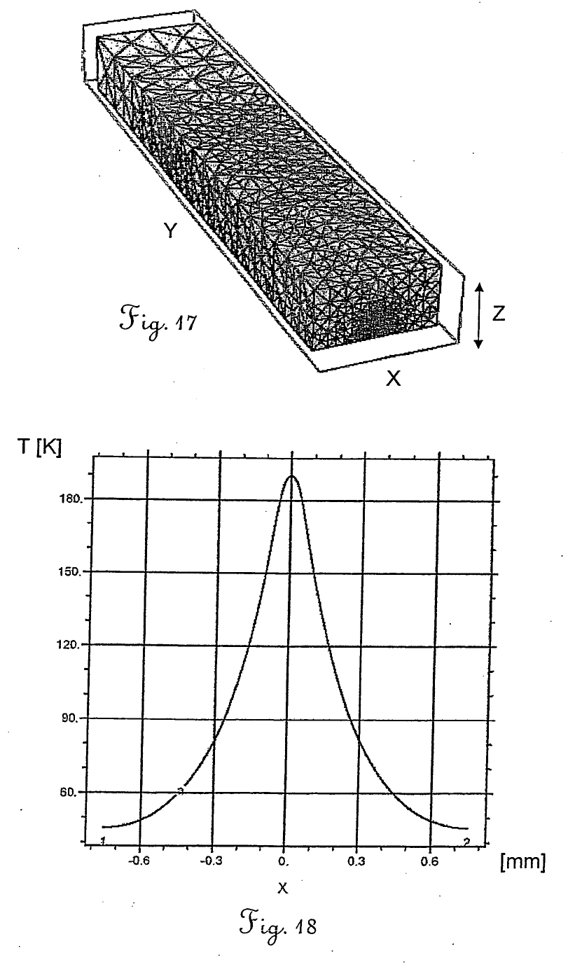

FIG. 18 show the temperature curve in the X-direction through the solid according to FIG. 17;

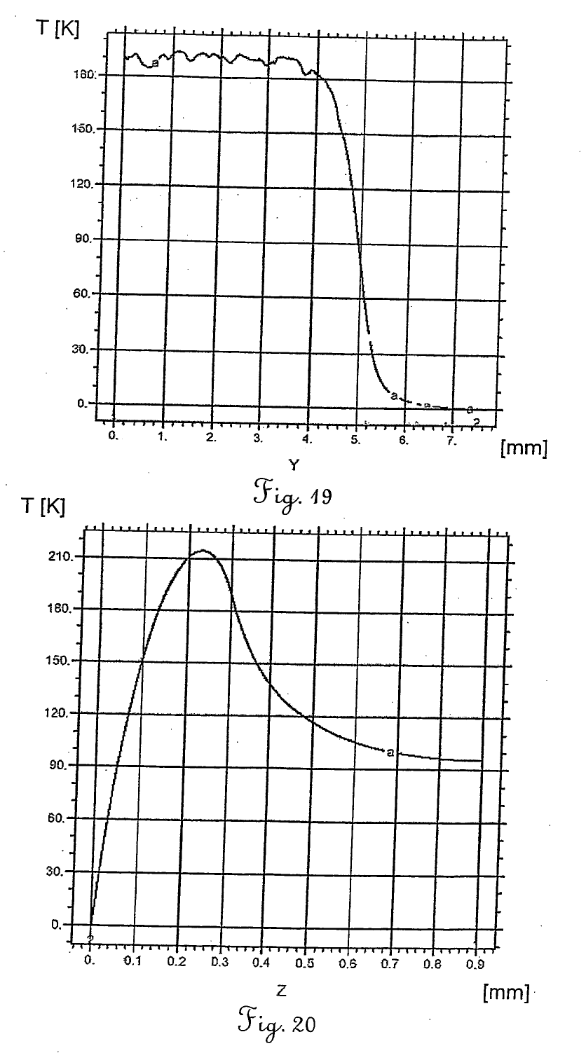

FIG. 19 shows the temperature curve in the Y-direction through the solid according to FIG. 17;

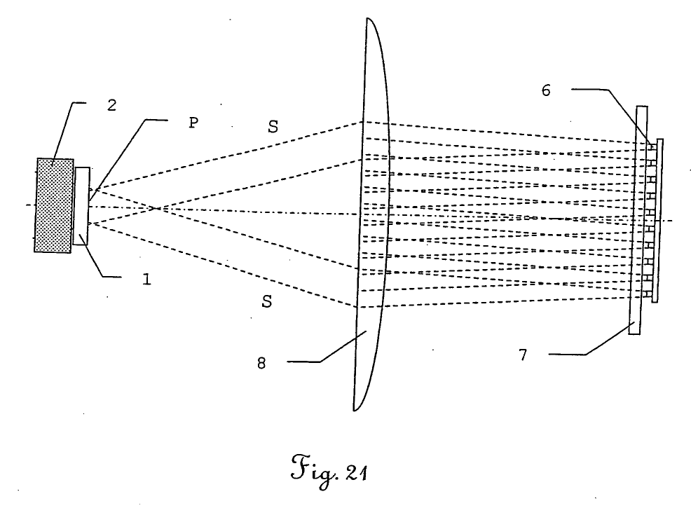

FIG. 20 shows the temperature curve in the Z-direction through the solid according to FIG. 17 and

FIG. 21 shows the schematic diagram of a laser arrangement according to the invention.

In FIG. 1, a laser medium 1 and a pumped light beam S for a laser arrangement according to the invention are shown. The thin laser medium 1 is mounted on a temperature sink 2 which is in the form of a cooled solid. The ray S of a pumped light beam is incident at an angle (e.g.: Brewster angle) on the laser medium 1 and, after passing through said medium, is reflected by a reflective layer 3 which is mounted between laser medium 1 and temperature sink 2. The pumped light beam S is reflected back into itself at a mirror 4 and once again passes through the laser medium 1 with reflection at the reflective layer 3.

Possible examples of pumped light geometries suitable according to the invention are shown in FIG. 2a-b. The pumped light spot in FIG. 2a which is focused onto the laser medium 1 is composed of a series of projections 5 which together define a pumped light spot P, where said projections may either originate from different emitters or light sources or may be produced by multiple imaging of the radiation of a light source, for example by multiple reflections. In their totality, these individual projections 5, which are shown here purely by way of example as being round and with only a slight overlap, form a common and substantially elongated or elliptical pumped light spot P, which advantageously conforms to the geometry of the laser medium 1. FIG. 2b shows, as a first alternative, the formation of an individual, homogeneous pumped light spot P, which may be formed, for example, by the appropriately shaped projection 5′ of the radiation of a single emitter. Advantageously, however, identically shaped light of a plurality of emitters can be superposed to form a homogeneous pumped light spot. A solution suitable for this purpose is described in WO 00/77893 and further executed in FIG. 21. The in any case elongated arrangement of semiconductor lasers can also particularly advantageously be utilized in a one-line or multiline linear array in order to generate an elongated pumped light spot.

In FIG. 3, an example of the use of multiple reflections for generating an elongated pumped light spot P is explained. As disclosed, for example, in U.S. Provisional Patent Application No. 60/442,917, a multiple reflection with variable spacing of the reflection points can be achieved by a mirror surface 4′ tilted relative to another surface, which multiple reflection leads to reversal of the direction after a certain number of reflections. In this example, the reflections occur between the mirror surface 4′ and the reflective layer 3, which in turn is mounted between laser medium 1 and temperature sink 2. In this setup, the pumped light beam S is input from one side and output again so that an arrangement which is advantageous in terms of design is possible. Alternatively, however, the mirror surface 4′ may also be arranged plane-parallel to the reflective layer 3 so that a reversal of direction of the ray S is effected by a further mirror in a manner known per se.

In an analogous manner, the laser mode and hence the radiation field to be amplified can also be passed several times through the laser medium and thus experience multiple amplification.

FIG. 4 schematically shows the formation of a pumped light spot P according to the invention on a laser medium 1 in an arrangement according to FIG. 3. The individual projections 5″ or reflections occur in this example with variable spacing so that the individual projections 5″ formed thereby have different distances from one another. By suitable choice of beam diameter, beam convergence and divergence, distance and angle of the reflective surfaces relative to one another, the sequence of reflection points can be varied up to a substantial overlap, so that a substantially homogeneous pumped light spot P forms.

A possible structure of the solid containing the laser medium is shown in FIG. 5a-b. In FIG. 5a, the structure consists of a layer sequence applied to the temperature sink 2 and comprising reflective layer 3, doped solid-state material 1a and undoped solid-state material 1b. The two solid-state materials may be joined to one another as separate elements by diffusion bonding or other bonding methods. An extension of the layer sequence is shown in FIG. 5b. Here, an additionally reflection-reducing and/or abrasion-resistant layer 1c is additionally applied to the undoped solid-state material 1b. Optionally, this layer 1c may also perform the function of the reflective surface from FIG. 3, so that the multiple reflection takes place completely in the interior of the solid.

FIG. 6 schematically shows different geometrical embodiments of a solid comprising the laser medium. Two purely exemplary embodiments of the laser-active solid 1A-1B according to the invention and a further embodiment of a solid 1C are shown, these being shown in their orientations with respect to the sequence of the incident rays S as a pumped light beam. The first embodiment of the solid 1A is lamellar, the two edges which define the surface of incidence facing the pumped light beam being greater than the thickness of the solid 1A. A second embodiment of the solid 1B has two edges of equal length, the third edge having a comparatively great length, so that the solid corresponds to an ingot having a square cross-section. In the third embodiment of the solid 1C, one of the two edges which define the surface of incidence facing the pumped light beam is very much greater than the thickness of the solid 1C, whereas the other edge is slightly smaller than this thickness. Thus, the solid 1C corresponds in its orientation relative to the rays S to an ingot having a rectangular cross-section which stands on its narrow side. However, the effect according to the invention can be used with increasing deviation from extensive contact—as occurs in the case of a lamellar first embodiment of the solid 1A—so that, for the third embodiment, with increasing ratio of lateral surface area to standing surface area, the effect according to the invention is reduced and finally only predominantly one-dimensional heat flow takes place.

FIG. 7 schematically shows the particularly advantageous adaptation of pumped light spot P and solid 1D. The geometry of the solid 1D is chosen so that it substantially corresponds to the geometry of the pumped light spot P. Consequently, substantial illumination of the solid 1D by a sequence of rays S as a pumped light beam and a cooling effect according to the invention can be achieved. At the same time, such an adaptation permits a compact or flat design and direct imaging of linear arrangements of the emitters or a linear emission geometry of a single emitter, so that the setup need not be complex.

FIG. 8 shows the schematic diagram of a second embodiment of the solid to be pumped according to the invention. In this embodiment, substantial adaptation of the geometries of solid 1E to be pumped and pumped light spot P are dispensed with. In this embodiment, only part of the solid 1E is illuminated by a sequence of rays S as pumped light. By means of such a design, it is possible to ensure that the horizontal temperature drop per unit length of the pumped light spot P occurring transversely to the longitudinal direction is kept small. However, with the same size of the pumped light spot P, these embodiments subsequently have larger dimensions so that it is necessary to dispense with possibilities for compact design of the laser in comparison with the first embodiment according to FIG. 7.

The models or results shown in FIG. 9-20 were calculated by the method of finite elements. The calculations were carried out using the program “Flex PDE 3D”. Only the temperature distributions were calculated, and the stresses or flexes were neglected. The calculation grid is determined by the program itself. The simulation problem was halved, i.e. half the material was neglected owing to mirror symmetry. The material of the solid was based on vanadate doped with 1% of neodymium.

Dimensions of the solid:

Half length 7.5 mm (FIG. 13 and FIG. 17), 2.5 mm (FIG. 9)

Width 1.5 mm (FIG. 13 and FIG. 17), 5 mm (FIG. 9) Height 0.3 mm (+0.6 mm for FIG. 17)

The contacted cooling surface is fixed at one temperature, the other surfaces are free with regard to the temperature and are not cooled. Consequently, all temperatures of the simulation give the difference relative to the cooling temperature. The program MATLAB was used for calculating the three-dimensional pumped light distribution in the material. Said calculation was carried out according to Beer's law, with reflection on the cooling side and while neglecting the fading effect.

The following were taken as parameters:

Pumped length 10 mm (FIG. 13 and FIG. 17), 1 mm (FIG. 9)

Pumped width 0.1 mm (FIG. 13 and FIG. 17), 1 mm (FIG. 9)

Absorption coefficient α=15 cm⁻¹

Pumping power 200 W (absorbs 120 W)

Heat efficiency ηₕ=35%, i.e. heating power 42 W

Thermal conductivity λ=5.1 W/(m·K)

All parameters were assumed to be temperature-independent.

FIG. 9-12 show the ratios in the simulation of a solid and pumped light beam of associated geometry of the prior art. The quantities are stated in mm, and the temperatures are stated in degrees Kelvin as a difference relative to the temperature sink.

FIG. 9 shows the model on which the simulation is based and which is obtained by the method of finite elements. A laser medium of a thin-disk laser having a square cross-section, on which a circular pumped light beam is incident, is considered. The laser medium is a homogeneous and doped solid. For symmetry reasons, it is sufficient—as shown—to simulate only half the solid. The three axes of the solid are stated.

FIG. 10 shows the temperature curve on the surface of the solid according to FIG. 9 along the X-axis. The center of the pumped light spot heats up in the example shown to almost 1000° Kelvin as a difference relative to the temperature sink.

FIG. 11 shows the temperature curve on the surface of the solid according to FIG. 9 along the Y-axis. Since only half the symmetrical arrangement was simulated, the temperature curve corresponds substantially to the right half of the temperature curve according to FIG. 10.

FIG. 12 shows the temperature curve in the interior of the solid according to FIG. 9 along the Z-axis.

FIG. 13-16 show the conditions in the simulation of a first embodiment of a solid and associated pumped light beam in a laser arrangement according to the invention. The laser medium is a homogeneous and doped solid. The quantities stated are in mm, and the temperatures stated are in degrees Kelvin as a difference relative to the temperature sink.

FIG. 13 shows the model on which the simulation is based and which is obtained by the method of finite elements. A first embodiment of a laser medium for a thin-disk laser according to the invention is considered, the laser medium being elongated and having a rectangular cross-section. An elongated or elliptical pumped light beam is incident on the laser medium as a solid. For symmetry reasons, it is sufficient—as shown—to simulate only half the solid. The three axes of the solid are shown. Both the dimension in the X-direction and that in the Y-direction are greater than the thickness of the solid (Z-direction). The total incident power corresponds to the example of FIG. 9-12.

FIG. 14 shows the temperature curve on the surface of the solid according to FIG. 13 along the X-axis. The center of the pumped light spot heats up in the example shown only to about 270° Kelvin as a difference relative to the temperature sink.

FIG. 15 shows the temperature curve on the surface of the solid according to FIG. 13 along the Y-axis. In contrast to the temperature curve according to FIG. 11, in the embodiment according to the invention a region of substantially constant and substantially lower temperature forms in the longitudinal direction.

FIG. 16 shows the temperature curve in the interior of the solid according to FIG. 13 along the Z-axis.

FIG. 17-20 show the conditions in the simulation of a second embodiment of a solid and associated pumped light beam in a laser arrangement according to the invention. The laser medium is a heterogeneous solid having a doped and an undoped region. The quantities stated are in mm, and the temperatures stated are in degrees Kelvin as a difference relative to the temperature sink.

FIG. 17 shows the model on which the simulation is based and which is obtained as a method of finite elements. A second embodiment of a laser medium for a thin-disk laser according to the invention is considered, the laser medium being elongated and having a rectangular cross-section. In contrast to FIG. 13, however, the solid consists of a first region of doped material on which a second region of undoped material or another inactive material was applied. An elongated or elliptical pumped light beam is incident on the surface of this total solid. For symmetry reasons, it is sufficient—as shown—to simulate only half the solid. The three axes of the solid are shown. Both the dimension in the X-direction and that in the Y-direction are greater than the thickness of the solid (Z-direction). The total incident power and power density—and hence the theoretical small-signal gain factor—correspond to that of the example of FIG. 9-12 or of FIG. 13-16.

FIG. 18 shows the temperature curve at the maximum in the interior of the solid according to FIG. 17 along the X-axis. The center of the pumped light spot heats up in the example shown only to about 190° Kelvin as a difference relative to the temperature sink.

FIG. 19 shows the temperature curve at the maximum in the interior of the solid according to FIG. 17 along the Y-axis. In contrast to the temperature curve according to FIG. 11, in the embodiment according to the invention a region of substantially constant temperature forms here too in the longitudinal direction.

FIG. 20 shows the temperature curve in the interior of the solid according to FIG. 17 along the Z-axis. Owing to the region of undoped material, improved cooling is achieved. The temperature maximum is now in the interior of the solid.

FIG. 21 shows an example of a laser arrangement according to the invention. As a light source for pumping the laser medium 1, laser diodes 6 are used as emitters or light sources of rays and are arranged linearly in an array. The respective ray S of these laser diodes 6 is focused by means of a first optical element 7 and a second optical element 8 as a pumped light beam onto the laser medium 1 mounted on the temperature sink 2. In this setup, the light of each laser diode 6 is focused to a common elongated pumped light spot so that the light spots substantially overlap and failure of an individual emitter does not change the structure of the pumped spot. As a result of the divergence of the light emanating from the laser diode 6 and the deflection by the second optical element 8, an elongated pumped light spot can be produced on the laser medium 1, which pumped light spot corresponds to the shape of the laser medium 1. This setup represents only one possible example of beam generation and beam guidance. In particular, a beam path can also be realized with this concept using multiple reflections. Furthermore, the linear structure of a laser array can be utilized for directly producing an elongated pumped light spot. For example, cylindrical lenses can be used as a first and second optical element, but other embodiments, e.g. holograms or gradient optical components, can also be realized.

Of course, the figures shown represent one of many embodiments, and the person skilled in the art can derive alternative realization forms of the laser setup, for example using other laser setups or resonator components. In particular, it is possible to realize the beam guidance or the cross-section of the pumped light differently from the examples given, for example by means of a suitable form or arrangement of reflective surfaces.

1. A thin-disk laser pumping method, comprising
a laser medium (1),
a temperature sink (2) on which the laser medium (1) is arranged, and
at least one light source for generating a ray (S),
comprising the steps
generation of the pumped light from the at least one ray of the at least one light source,
radiation of the pumped light onto an entry surface of the laser medium (1), which entry surface is opposite the temperature sink (2),
wherein, when the pumped light is incident on the entry surface, a pumped light spot (P) having a ratio of length to width of at least 2:1 is produced and a two-dimensional heat flow is generated, the pumped light spot (P) being formed by a single ray (S) or the combination of a plurality of rays (S).

2. The thin-disk laser pumping method as claimed in claim 1, wherein the width of the pumped light spot is less than the thickness of the laser medium (1), in particular the width of the pumped light spot is 0.1 mm, and the thickness of the laser medium (1) is greater than 0.3 mm, in particular 0.9 mm.

3. The thin-disk laser pumping method as claimed in claim 1, wherein, during incidence, the pumped light spot (P) is formed by arranging the rays (S) of a plurality of light sources in series.

4. The thin-disk laser pumping method as claimed in claim 1, wherein, during incidence, the pumped light spot (P) is formed by the rays of a plurality of light sources with substantial overlapping of the rays (S).

5. The thin-disk laser pumping method as claimed in claim 1, wherein, during incidence, the pumped light spot (P) is formed by arranging multiple projections (5″) of the ray (S) of the light source in series.

6. The thin-disk laser pumping method as claimed in claim 5, wherein the multiple projections (5″) are realized by multiple reflection of the ray (S) of the light source at a reflective surface (4′).

7. The thin-disk laser pumping method as claimed in claim 1, wherein, during incidence, the pumped light spot (P) is produced with a ratio of length to width of at least 3:1, 5:1 or 10:1.

8. The thin-disk laser pumping method as claimed in claim 1, wherein, after reflection of the pumped light at an interface with the temperature sink, the pumped light experiences back-reflection.

9. The thin-disk laser pumping method as claimed in claim 1, wherein multiple reflection of the pumped light takes place within the laser medium (1).

10. A thin-disk laser arrangement comprising
at least one light source for generating a ray (S),
a laser element having a temperature sink (2) and a first component (1a) comprising a laser-active material, the first component (1a) and the temperature sink (2) being connected to one another by a heat-conducting bond,
means for radiating pumped light onto an entry surface of the laser element, the means for radiating being arranged and formed so that the radiation takes place onto an entry surface of the laser medium which is opposite the temperature sink (2),
wherein the means for radiating in pumped light are formed and arranged so that a pumped light spot (P) having a ratio of length to width of at least 2:1 is formed and a two-dimensional heat flow is generated, the pumped light spot (P) consisting of a single ray (S) or the combination of a plurality of rays (S).

11. The thin-disk laser arrangement as claimed in claim 10, wherein the width of the pumped light spot is less than the thickness of the laser medium (1), in particular the width of the pumped light spot is 0.1 mm, and the thickness of the laser medium (1) is greater than 0.3 mm, in particular 0.9 mm.

12. The thin-disk laser arrangement as claimed in claim 10, wherein
a reflective first surface, in particular as reflective layer (3), is formed between first component (1a) and temperature sink (2) and
the means for radiating in the pumped light have a planar reflective second surface (4′) for folding the beam path of the ray (S), the reflective surfaces (3, 4′) being arranged so that
a. the reflective surfaces (3, 4′) are oriented
i. relative to one another and
ii. with divergence, in particular adjustable divergence, of the surfaces (3, 4′),
and
b. the ray (S) is reflected at least twice at at least one of the reflective surfaces (3, 4′).

13. The thin-disk laser arrangement as claimed in claim 10, comprising a plurality of linearly arranged semiconductor laser diodes (6) as light sources,
the means for radiating in pumped light having a first optical element (7) and a second optical element (8),
the first optical element (7) collimating each ray in a first plane,
the second optical element (8) collimating each ray in a second plane substantially perpendicular to the first plane, and guiding the rays (S) so that the pumped light spot (P) is defined by
arrangement of the rays (S) in series
or
substantial overlap of the rays (S).

14. The thin-disk laser arrangement as claimed in claim 13, wherein the first optical element (7) is a cylindrical lens and/or the second optical element (8) is a cylindrical lens.

15. The thin-disk laser arrangement as claimed in claim 10, comprising a beam path which is formed, in particular by an arrangement of folding mirrors, so that the laser mode is multiply propagated by the laser element.

16. The thin-disk laser arrangement as claimed in claim 15, wherein the beam path is formed in a resonator or in a unidirectional amplifier.

17. The thin-disk laser arrangement as claimed in claim 10, comprising a rectangular cross-section of the heat-conducting bond, in particular having a ratio of length to width of at least 2:1.

18. The thin-disk laser arrangement as claimed in claim 10, wherein the laser medium has a second component (1b) of a material which has a refractive index identical to the laser-active material, the second component (1b) being connected to the first component on a side facing away from the temperature sink (2) by a heat-conducting bond.

19. The thin-disk laser arrangement as claimed in claim 18, wherein first component (1a) and second component (1b) consist of an identical base material and differ only in doping.

20. The thin-disk laser arrangement as claimed in claim 18, wherein first component (1a) and second component (1b) are in the form of a monolithic solid, at least one dimension of the solid which is parallel to the temperature sink (2) being greater than the thickness thereof measured perpendicularly to the temperature sink.

21. The thin-disk laser arrangement as claimed in claim 20, wherein the solid has a strip-like or ingot-like geometry.

22. The thin-disk laser arrangement as claimed in claim 20, comprising a reflective layer (3) between solid and temperature sink (2).

23. The thin-disk laser arrangement as claimed in claim 20, comprising a reflection-reducing and/or abrasion-resistant layer (1c) on a side of the solid which faces away from the temperature sink (2).
